(19) United States
(12) Patent Application Publication
(10) Pub. No.: US 2006/0066094 A1
(43) Pub. Date: Mar. 30, 2006

(54) Display book with viewing compartment and self-illumination

(76) Inventors: Gabriella Piomboni, New York, NY (US); Stefano Campolmi, Milano (IT)

Correspondence Address: MORGAN & FINNEGAN, L.L.P., 3 World Financial Center, New York, NY, 10281-2101, US

(21) Appl. No.: 11/282,440

(22) Filed: Nov. 17, 2005

Related U.S. Application Data
(63) Continuation-in-part of application No. 10/450,132, filed on May 30, 2003.
(60) Provisional application No. 60/630,425, filed on Nov. 23, 2004.

(51) Int. Cl. B42D 3/00

(52) U.S. Cl. 281/29

(57) ABSTRACT

The present invention relates to a display book system comprising a frame which defines a viewing window and a passé-par-tout which defines a viewing compartment, in a position aligned with the window of the frame, for accommodating a subject to be displayed and which is visible through the viewing window of the frame. A book portion can be annexed thereto to form the display book system. In alternative embodiments, a display book system is modified to provide a viewing compartment formed in association with the framed picture portion (frame, passé-par-tout) to allow display of discrete objects including three dimensional objects such as figurines as well as images and pictures, opaque or translucent, which are substantially two dimensional. Illumination capability is provided to allow lighting of the object displayed (front or back-lit) or self illumination. The frame itself can also be illuminated for, e.g., decorative motivation.

### RELATED APPLICATIONS

Priority is claimed in this application under 35 U.S.C. §119(e) to U.S. provisional application Ser. No. 60/630,425, filed Nov. 23, 2004, and under 35 U.S.C. §120 as a continuation in part of co-pending U.S. patent application Ser. No. 10/450,132 which was a 35 U.S.C. §371 national stage filing under PCT Application PCT/IT02/00638 filed Oct. 8, 2002, each of which applications are incorporated herein in their entirety by reference.

### FIELD OF THE INVENTION

This invention relates generally to display systems and methods, and more specifically, to a system and method for displaying objects and images in a book-display combination.

### BACKGROUND INFORMATION

Framed pictures and books have always been well distinct and separate articles: framed pictures are monolithic objects, to be hung on a wall, to be used from a certain distance and in which the visual aspect prevails; books are articles that are divided into different components, to be handled, to be used in a near distance and in which the intellectual aspect prevails.

The considerations made in relation to framed pictures are valid also for other articles provided with a frame similar to that of pictures.

Framed pictures have traditionally been limited to display unitary objects, such as paintings or other images and books to image and text on a series of pages. Relief images may be presented within a frame and three dimensional objects may be integrated as pages in a book. However, the utility of each item, a framed picture, object or a book, remain in this context.

Therefore, in view of the background information presented hereinabove, the need is manifest for advances in display systems such as would combine the salient features of the respective separate objects of book and framed pictures/objects.

### SUMMARY OF THE INVENTION

The present invention provides advancements over the background and prior art by providing a display book with a viewing compartment and self illumination.

In accordance with an aspect of the present invention, it is one object of the present invention to combine said articles, in particular a book and a framed picture in a useful manner for purposes of a novel display system.

Said combination has is particularly useful if, for example, the subject of the picture or object to be displayed and the subject of the book are the same or if they are related to each other: for example, a work by a particular artist and a description of that work or the artist.

In order to achieve this object in one embodiment, two considerations have been made: the consideration that both the framed picture and the book are objects substantially flat and the additional consideration that both the component parts of a framed picture (the frame, the passé-par-tout, the painting) and both the components of a book (the cover, the pages) are objects substantially flat.

Based on these considerations, the two articles can be not only combined, but also integrated into a single apparatus.

The articles according to the one embodiment of the present invention maintain the structure of a book (a plurality of pages ordered and bound together) but the first page(s) emulate the structure of a framed picture (frame, passé-par-tout, artistic subject) totally or partially combined.

In an alternative embodiment, a display system comprising book and framed picture features as described above, is modified to provide a viewing compartment formed in association with the framed picture portion (frame, passé-par-tout) to allow display of discrete objects including three dimensional objects as well as images and pictures which are substantially two dimensional. As will be discussed in detail with respect to the illustrative embodiments presented hereinbelow, the term “two dimensional” subject/object is used to refer to an object where the e.g., depth dimension, is negligible when compared to the length and width dimension, for example, as in a picture or translucent image, and the term “three dimensional” subject/object is used to refer to an object where the e.g., depth dimension, is more dimensionally significant when compared to the length and width dimension, for example, a figurine. In a further enhancement to the present invention, illumination capability is provided in the book to allow lighting of the object displayed (front, top, side or back-lit). The object itself can also be supplied with power for self illumination and the frame itself can also be illuminated for, e.g., decorative motivation.

It will be appreciated by those skilled in the art that the foregoing brief description and the following detailed description are exemplary and explanatory of this invention, but are not intended to be restrictive thereof or limiting of the advantages which can be achieved by this invention. Thus, the accompanying drawings, referred to herein and constituting a part hereof, illustrate preferred embodiments of this invention, and, together with the detailed description, serve to explain the principles of this invention.

### BRIEF DESCRIPTION OF THE DRAWINGS

Additional aspects, features, and advantages of the invention, both as to its structure and operation, will be understood and will become more readily apparent when the invention is considered in the light of the following description made in conjunction with the accompanying drawings, wherein:

FIG. 1 shows a schematic perspective view of an article according to the present invention.

FIG. 2 shows a schematic view according to the plane A-A of the article of FIG. 1.

FIG. 3 show a cross-section view of an example of a frame page for an article according to the present invention.

FIG. 4 shows a cross-section view of another example of a frame page for an article according to the present invention.

FIG. 5 shows a cross-section view of a first example of a passé-par-tout page for an article according to the present invention.

FIG. 6 shows a cross-section view of a second example of a passé-par-tout page for an article according to the present invention.

FIG. 7 shows a cross-section view of a third example of a passé-par-tout page for an article according to the present invention.

FIG. 8 shows a cross-section view of a fourth example of a passé-par-tout page for an article according to the present invention.

FIG. 9 shows a perspective view of an illustrative embodiment according to the present invention for displaying a three dimensional object.

FIG. 10 shows a perspective view of the illustrative embodiment of FIG. 9 adapted to display a relief image.

FIGS. 11A and 11B show an illustrative embodiment according to the present invention for changeably displaying a three dimensional object.

FIGS. 12A and 12B show an alternative illustrative embodiment according to the present invention for changeably displaying a three dimensional object.

FIGS. 13A, 13B and 13C show alternative illustrative embodiments according to the present invention for displaying a three dimensional object.

FIGS. 14 and 15A & 15B show an alternative illustrative embodiment according to the present invention for changeably displaying a three dimensional object.

FIGS. 16 (A & B), 17 (A, B & C) and 18 show perspective views of an illustrative embodiment according to the present invention that includes an illumination system for displaying an object with illumination.

FIGS. 19A and 19B each show a perspective view of an illustrative embodiment according to the present invention for displaying a back-lit image.

FIGS. 20 (A & B) and 21 (A, B & C) show an alternative illustrative embodiment according to the present invention for changeably displaying a back-lit image.

FIGS. 22 (A & B) show the embodiments of FIGS. 13A and B/C in alternative illustrative embodiments according to the present invention wherein the displayed object is illuminated.

FIG. 23 (A & B) show an illustrative embodiment of FIGS. 16, 17 and 18 further including a closure mechanism.

FIG. 24 shows an illustrative embodiment according to the present invention for displaying a front- or perimeter-lit object.

FIGS. 25 and 26 show an illustrative embodiment according to the present invention for displaying an illuminated pattern or design on the frame.

FIG. 27 (A & B) shows an illustrative embodiment according to the present invention for displaying multiple objects.

### DETAILED DESCRIPTION OF EMBODIMENTS OF THE INVENTION

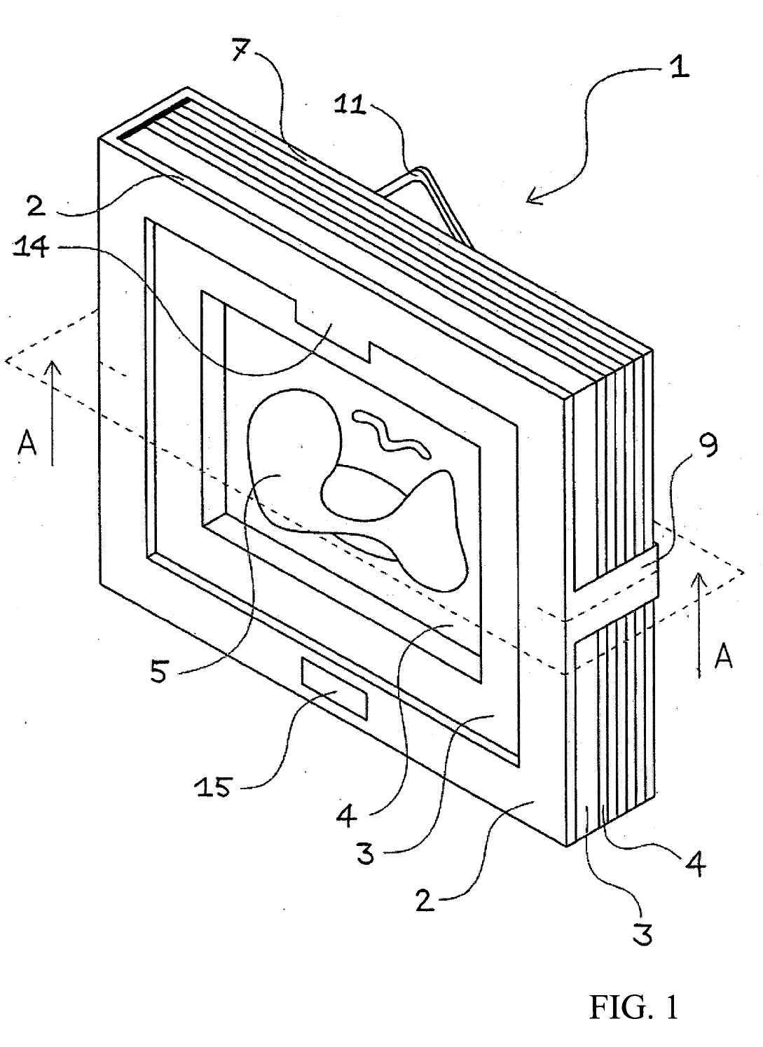

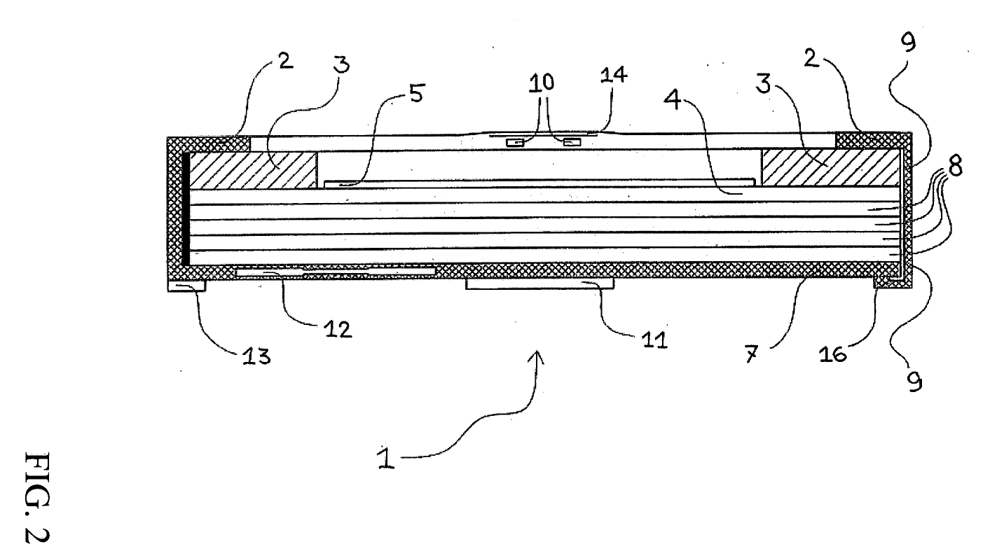

In accordance with an illustrative embodiment of the present invention herein described, the article according to the present invention has substantially the shape of a book and comprises a plurality of pages ordered and bound together; the present invention is independent of the type of binding used; among the binding types normally used in the book (publishing) area we can mention: saddle stitches, sewn signatures, spiral binding, paperback binding; the examples shown in FIG. 1 and FIG. 2 have both a paperback binding.

In the article according to the present invention, the first page acts as the cover of the book; the first page comprises or it is constituted essentially by a frame; the frame defines its own window; on a following page of the book it is represented or applied or specifically applicable, in a position aligned with the window of the frame, a subject preferably artistic, flat or in relief; the subject is visible through the window of the frame when the book is closed.

The article according to the present invention integrates the functions of two different articles: an article with a frame (typically a framed picture) and an article with bound pages (typically a book); many can be the articles with a frame; many can be also the articles with bound pages, for example: books strictly for reading, illustrated books, activity books, coloring books, etc.

As will be better clarified further below, according to the present invention, many are the subjects adapted to be shown through the frame, either of substantially bi-dimensional or three-dimensional type, and either of strict artistic type or broader artistic type. Depending on the type of the subject, this can be more advantageously represented (for example printed or drawn) or applied (for example glued) or specifically applicable (for example by inserting it in a pocket of transparent material or by being imbedded in a niche). The position of the subject must take into consideration the position of the window of the frame both to make sure that the subject is visible through the window of the frame when the book is closed and to give a pleasant esthetic aspect (in some cases, for example it will be advisable to center the subject in relation to the window of the frame); there is not in any way the need to match the perimeter of the window with the perimeter of the subject.

The present invention is independent, in general, from the shape of the book, of the frame, of the window and of the subject; among the various shapes we can mention for example: square, rectangle, triangle, circle, and ellipse.

The frames that can be used for the article according to the present invention can be very different: a certain frame can resemble a traditional picture frame but can also resemble, for example, the frame of a television screen or the frame of a home window; a frame that can be used in the present invention can also be a multiple type, that is to say subdivided in more squares each surrounding a different subject or a different section of the same subject.

As far as the dimensions are concerned, typical applications of the present invention can have a vertical dimension (correspondent to the bulk of the book) from 1 cm up to 2 cm and a horizontal dimension from about 5 cm to 20 cm; however higher dimensions are not prohibited and can be employed for any given application as appropriate.

The present invention is also, in general, independent of the material used for the various pages of the book and for the subject; among the various materials we can mention, for example: paper, board, wood, fabric, glass, metal, plastic; a plastic material that could be used, in particular for articles according to the present invention addressed to children, is EVA (Ethylene Vinyl Acetate).

The present invention can include advantageously, but not necessarily, a passé-par-tout behind the frame; the passé-par-tout defines its own window aligned with the window of the frame and such so that the subject is visible also through the window of the passé-par-tout when the book is closed; the passé-par-tout can be used to give a feeling of depth. The position of the window of the passé-par-tout must take into consideration the position of the window of the frame either to make sure that the subject is visible through the window of the passé-par-tout when the book is closed and to give a pleasant esthetic aspect (in some cases for example, it will be advisable to center the subject in relation to the passé-par-tout); there is not in any way the need to match the perimeter of the window of the passé-par-tout with the perimeter of the window of the frame: for example, in the framed pictures, the passé-par-tout is often well visible behind the frame.

The considerations made above are also valid for the shape and for the material of the passé-par-tout.

A good perception of depth is obtained when the passé-par-tout has a thickness comprised between 1 mm and 1 cm approximately; however, larger thickness would certainly give a better perception of depth.

The present invention can include advantageously but not necessarily a transparent material in the form of a plate or pane in correspondence of the entire window of the frame and/or of the passé-par-tout; the transparent material can serve as protection of the subject or to improve the esthetic aspect of the article. Typically the transparent material used will be a kind of plastic both for reasons of weight and fragility, as well as for reasons of transparency; it is not excluded, however, that in some cases another type of material could be used, glass for example.

The transparent material can constitute an entire book page; or the transparent material can be applied (for example glued or embedded) to the frame or to the passé-par-tout; or in addition, the pane of transparent material can be integrated in the frame or in the passé-par-tout.

According to the present invention, any or all the parts of the article, the frame, the passé-par-tout, the pane of transparent material, the page associated with the subject can be present in the article and can be bound together in many different ways so as to form one or more pages of the article, for example not considering the pane of transparent material: (A) anyone of these elements can constitute one single page, (B) the frame and the passé-par-tout can be bound together so as to form one single page, (C) the passé-par-tout and the page associated with the subject can be bound together so as to form one single page, (D) the frame, the passé-par-tout and the page associated with the subject can be bound together so as to form one single page.

The example on FIG. 1 and FIG. 2 corresponds to the case in which the first page is constituted essentially by the sole frame.

In these figures, an article 1 in the form of a book according to the present invention comprises a plurality of distinct pages, ordered and bound together in a paperback form; the first page acts as the cover of the book and it is essentially constituted by a frame 2 which defines its own window 21; the second page is essentially constituted by a passé-par-tout 3 which defines its own window 31; the third page is constituted by a page 4 made of board with an artistic and substantially flat subject applied over (in a very schematic way, a painting); these three pages are followed (in this case) by four board and printed pages 8 which contain, among others, written text; at the end there is a page 7 which acts as back cover. The article 1 is shown in the figures in a closed position; in such a position, the subject 5 is visible both through the window 21 of the frame 2 and through the window 31 of the passé-par-tout 3.

In the article 1 of FIG. 1 and FIG. 2 according to the present invention is not included any pane of transparent material; this article however could be easily modified by inserting an entire page of transparent material, for example, between the first and second pages or gluing, for example, a pane of transparent material to the passé-par-tout 3.

The subject 5 of FIG. 1 and FIG. 2 is a painting.

As a first option, the subject can be a drawing or a print or a photographic image or something similar; part of this list are also, for example, the image of a comic strip or cartoon character and the image of a soccer player.

As a second option, the subject can be a photograph or something similar.

As a third option, the subject can be a stamp or a coin or something similar.

As a fourth option, the subject can be a lace or a piece of fabric or something similar.

As a fifth option, the subject can be a bas-relief or a high-relief or something similar.

Some of the subjects described above are artistic subjects in a strict sense, others are artistic subjects in a broader sense, other are not artistic at all.

The printed text on the pages 8 of the article 1 has a content related to the subject 5; this aspect is one of the key elements of the present invention.

Below are shown with the help of FIG. 1 and FIG. 2, other advantageous features of the present invention.

The article 1 can further include a device 11 to allow it to be hung on a wall. Such device is, in the illustrated embodiment, a ring, e.g., in triangular form, attached to the back page 7 via a small mounting plate. In this way, the function of a framed picture (or similar article) is more complete.

The article 1 can include a device 9 adapted, to, in a specific condition, to keep all the pages closed together; in particular it is a wrapper with a small tooth 16 to hook up with page 7 which is the back cover; such a closing device is useful in general, but it is particularly useful in combination with device 11: in fact, if the article 1 would be hung on a wall through device 11 without device 9, the article would tend to open up with the result that the frame 2 would not surround the subject 5 any longer.

For better placement of article 1 when hung on a wall, a thin strip 13 can be included as compensation for the depth of any device 9 or 11 and further more it is preferable, but not essential, that the strip 13, the tooth of the device 9 and the plate of the device 11 be of the same thickness.

With a choice of device 9 and device 11 different from that shown in FIG. 1 and FIG. 2, and having the same scope, it is possible to advantageously avoid any protuberance from page 7 of the back cover; in this case the ruler 13 becomes unnecessary.

The article 1 can comprise a device 10 adapted to light up the subject 5; it is in particular made of two micro light bulbs or two diodes of LED type (Light Emitting Diode) applied to the frame 2 on the top part of its window (when the article is hung) similar to framed pictures in museums; in correspondence of the two light bulbs it can be included, on the frame 2, a small screen 14 to avoid the dazzling effect and also to better direct the light towards the subject 5.

The lighting device can be made in many other ways and can be positioned in other parts of the article; it can be included in the frame 2 or in the passé-par-tout 3 or in neither one.

The article 1 shows a plate 15 on which in small letters it is reproduced the name of the author of the painting similarly to museums' framed pictures; naturally other additional information can be added to it.

The article 1 could also include a device adapted to reproduce sounds. Sounds can be music and/or voices and/or noise. The sound device can be, for example, an electronic system to record sounds, or a device to reproduce sounds and a device to emit sounds.

Both the lighting device and the sound device are electrical devices and they need electric power; in the case of an article according to the present invention, the only source of energy practically usable and with a limited cost are batteries; in the article 1 of FIG. 1 and FIG. 2 it is included a space 12 created on the page 7 of the back cover adapted to contain two batteries of the flat type. The batteries, or more in general, the devices for electric power production can also be positioned elsewhere.

Both the lighting device and sound device, when present in the article 1, need of a device which will turn on the light feature and the sound feature respectively; there are many practical options; the simplest option is constituted by a switch that can be operated manually; a more complex option is a switch that will turn on and off with the opening and closing of the book.

The article 1 could also have a device adapted to contain a CD or a DVD or a similar memory tool adapted to contain data and/or sound and/or images; such a device could be, for example, a pocket applied or created on the page 7 of the back cover. Also in this case there will advantageously be a correlation between the subject, the content of the text and the content of the CD or DVD.

As far as the types of materials, we have already said that there is ample choice; in a typical embodiment as the one of FIG. 1 and of FIG. 2, all the pages of the article 1 are made of board, but have different thickness; in particular the pages 8 are made of board and are all the same.

As we can understand from these figures, the article 1 not only can be hung on a wall, not only can be placed flat on its back cover, but it can also be placed standing up in perfect balance on the bottom side thanks to the thickness of its pages. The article according to the present invention does not exclude any other options of support already known in the field of the articles with bound pages or in the field of the articles in frames.

Some or all the pages of the article according to the present invention can be adapted to be written; the material that can be used in this case is typically paper.

Below are illustrated, with the help of the figures, the structures of some samples of frames and passé-par-tout adapted to this invention.

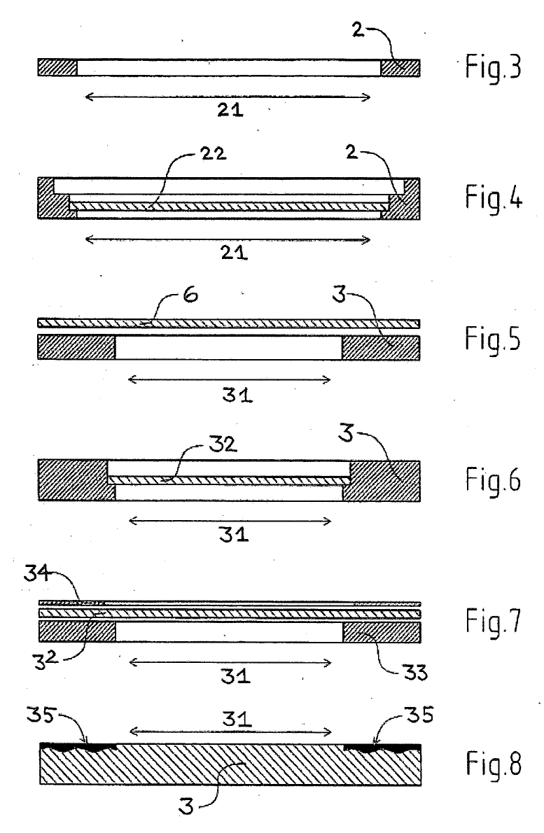

FIG. 3 shows a simple frame 2 with its own window 21.

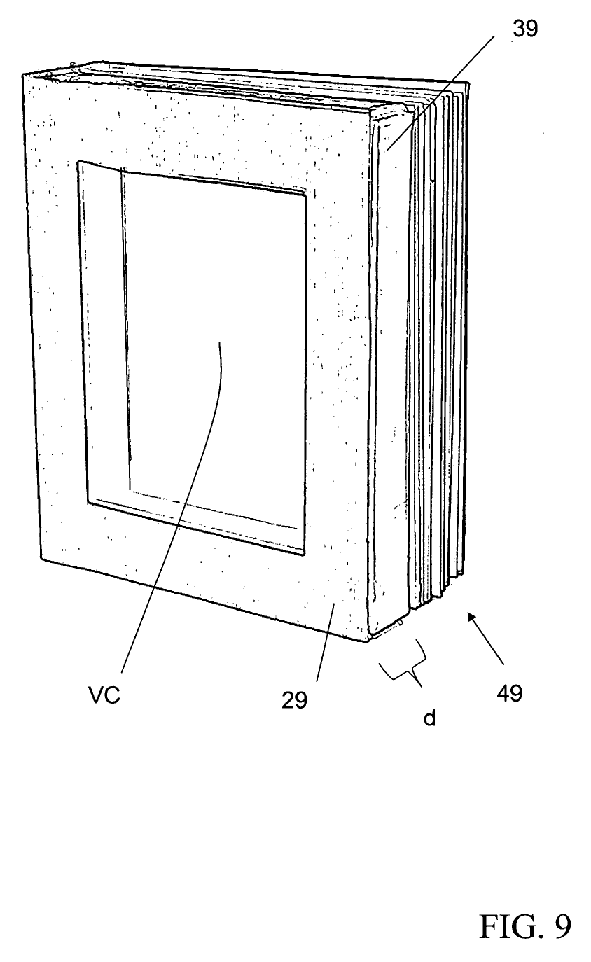

FIG. 4 shows a frame 2 with a border built in a step like manner; in one of the steps is inserted a pane 22 of transparent material.

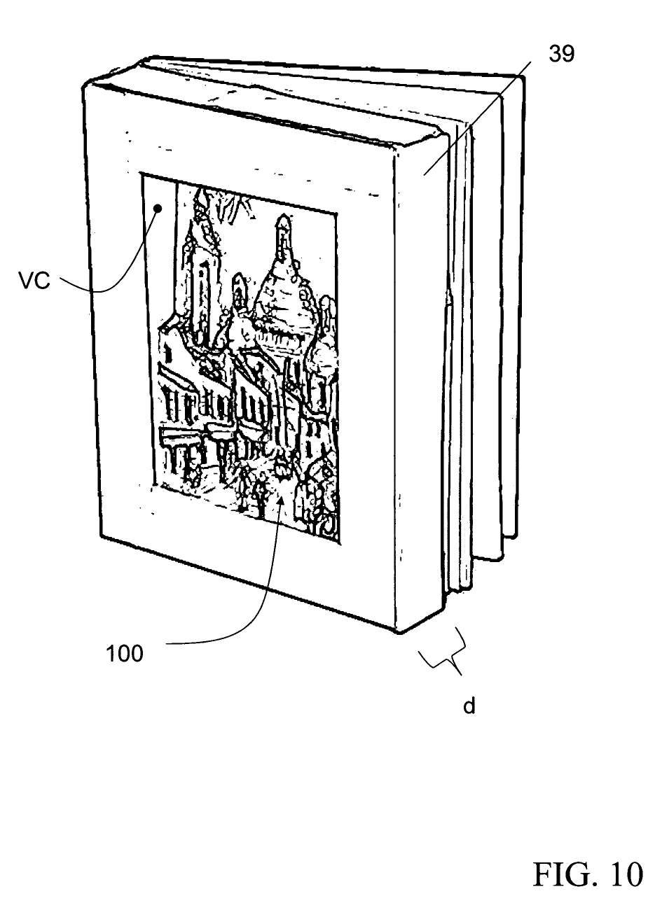

FIG. 5 shows a simple passé-par-tout 3 with its own window 31; it is also shown a pane 6 of transparent material separate from the passé-par-tout 3; as an alternative, this could be also glued to the passé-par-tout 3 and therefore could become a single page of the article.

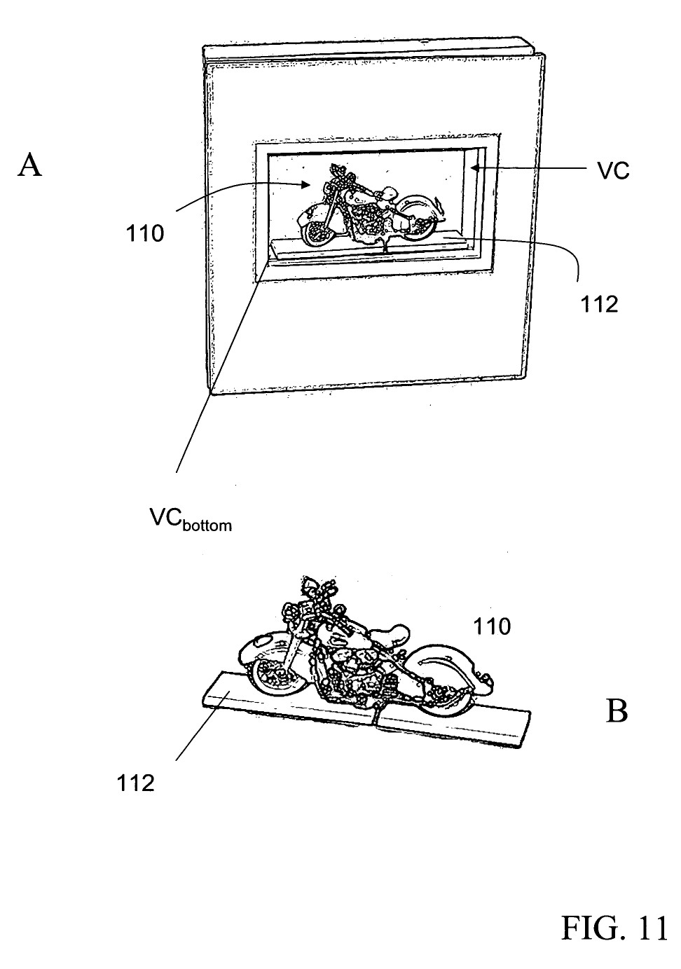

FIG. 6 shows a passé-par-tout 3 built in a step like manner; in one of the steps is inserted a pane 32 of transparent material.

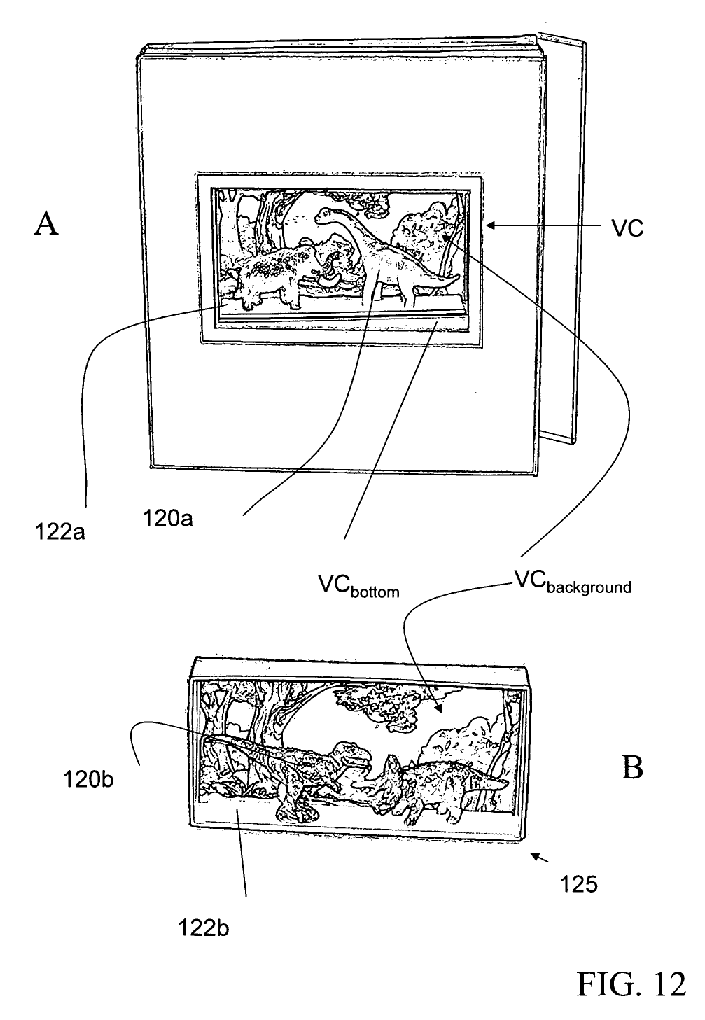

FIG. 7 shows a passé-par-tout 3 formed by a lower plate 33 (provided with a window) with a pane 32 of transparent material applied over, an additional upper plate 34 (provided with a window) is applied over to secure pane 32 to plate 33.

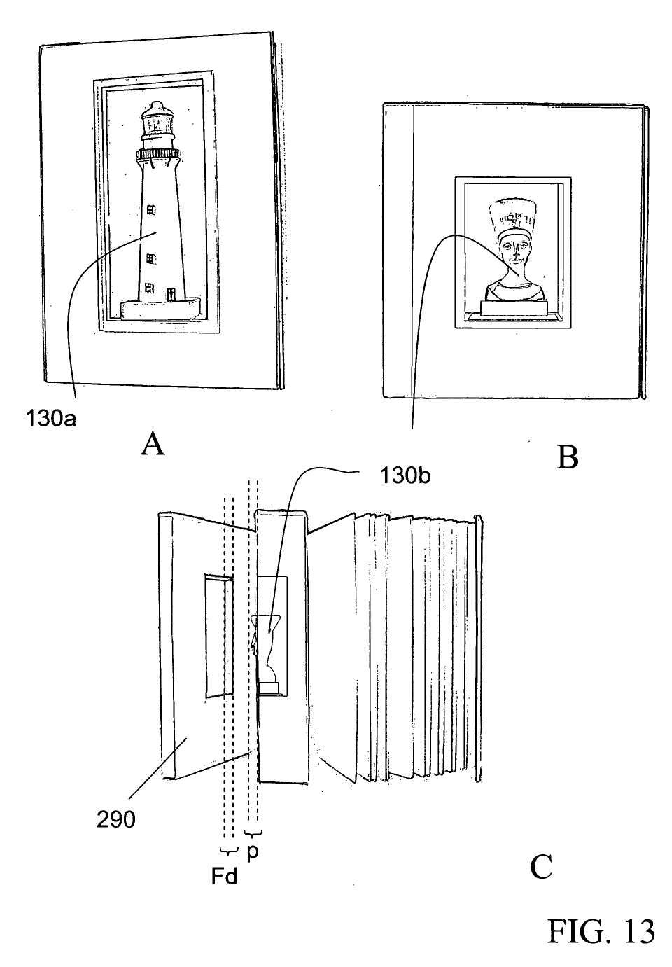

FIG. 8 shows a passé-par-tout 3 made of a thick pane of transparent material; in correspondence of the perimeter area of the top surface of the passé-par-tout 3 ink 35 has been applied; the inked surface defines the window 31 of the passé-par-tout.

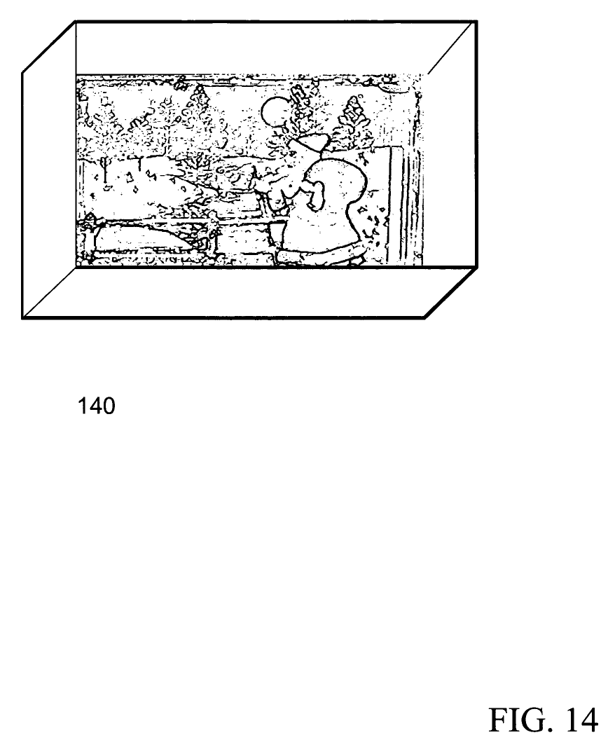

Alternative features incorporated into alternative embodiments of the present invention, some of which are shown for purposes of illustration in FIGS. 9-27, will now be described.

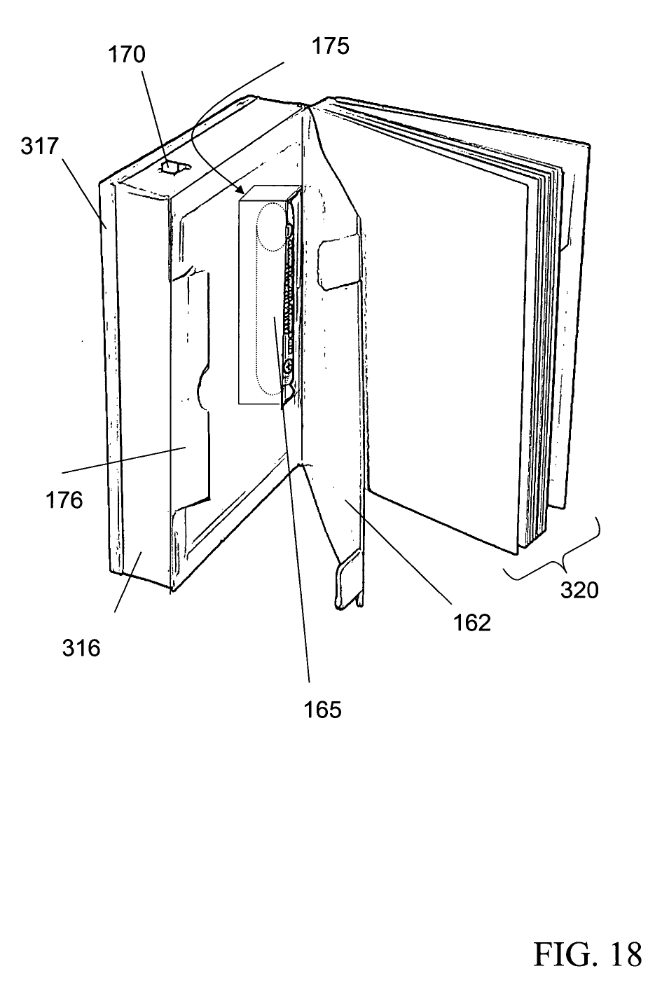

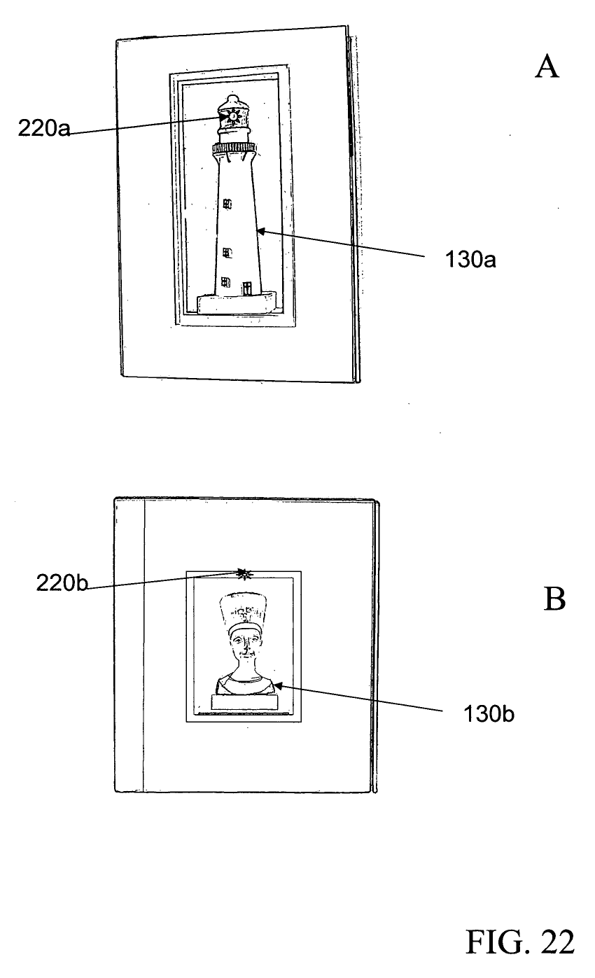

In the alternative embodiments as will be discussed in detail below, the display system comprising book and framed picture features as described above, is modified to provide a viewing compartment formed in association with the framed picture portion (e.g., frame and passé-par-tout) to allow display of discrete objects including three dimensional objects as well as images and pictures which are substantially two dimensional. As previously indicated, as intended herein, a “two dimensional” subject/object is used to refer to an object where the e.g., depth dimension, is negligible when compared to the length and width dimension, for example, as in a picture or translucent image as discussed with respect to FIG. 20. The term “three dimensional” subject/object is herein used to refer to an object where the e.g., depth dimension, is more dimensionally significant when compared to the length and width dimension, for example, as will be discussed with reference to FIG. 13. Two and three dimensional subjects can, if desired, be displayed in the same viewing box.

Further, in an enhancement thereto, illumination capability is provided in the book to allow lighting of the object displayed (e.g., front, top side or back-lit). The object itself can also be supplied with power for self illumination and the frame itself can also be illuminated for, e.g., decorative purposes.

As will be understood in exploiting the various teachings of the present invention, the display system may be constructed in different ways suitable to any one of a variety of specific applications. While examples are provided for purposes of illustrative explanation and discussed infra, variations, combinations and sub-combinations of the various features of the present invention will be clearly understood and are envisioned to be part of this disclosure and within the scope of the invention, although not all of which may be explicitly described herein.

As can be understood from the detailed description of alternative embodiments which follows, a viewing box or compartment hosting an item to be displayed does not necessarily need to be formed in any particular manner or be in any specific place in relation to the book article itself. That is, it does not need to be formed by e.g., gluing together the first three pages as described above. The compartment can be relationally disposed in the front, back or inside (somewhere in between the front and back) of the display book system with modifications accordingly made to the book frame to accommodate such placement (e.g., when the box is placed at the back of the book, the pages will be on the front (relative to the display box) and open to reveal the viewing box.) As will also be understood, when more than one box is incorporated into any single display book system/article, the one or more boxes may placed at random inside the display book system/article in various planes or pages (for example, towards the front, the middle and/or the rear) or positions (for example, towards the top, the vertical center and/or the vertical bottom of a page), each box formed according to the various aspects of the present invention described herein and each may be made separately (i.e., only one box can be seen at a given time) or communally (i.e., more than one box can be seen at a given time) viewable for any book position (open, partially open or closed). Also, a single display book can display more than a single type of subject, for example, an embodiment can be devised where a figurine (i.e., a three dimensional subject) is disposed in one viewing compartment, and a picture or image (i.e., a two dimensional subject) is displayed in a second viewing compartment.

Also, in any particular devised embodiment, the cover-frame or matte need not necessarily be present.

The subject image to be displayed in the book can be in a variety of formats in addition to those discussed above. For example, the image may be printed or transferred onto a piece of material such as acetate, so as to be translucent (e.g., including transparent). Such (translucent) images are for purposes of illustration incorporated in frame embodiments described herein which include a illumination device/system to allow backlighting of a displayed object or image. The illumination device in some embodiments places a light source behind the (translucent) image, diffusing the projected light and allowing viewing of the image. A diffuser panel can also be incorporated for further optical effect. The translucent images in such configurations are thus back-lit via the illumination device.

Such images may be interchangeable—i.e., not permanently fixed in the viewing field of the viewing box, where additional images can be stored in a “container” (e.g., a pouch) disposed inside or attached to the book.

The illumination devices/systems of the present invention can employ one or more LED's or other suitable light source, including, e.g., micro-lamps and side effect optical fibers. The illumination systems can be extended to diffuse the light all along the entire frame or viewing compartment, or any portion thereof, as suitable for any given application.

The illumination device is powered by a source suitable to the application as will be understood. For example, the power source for illumination can be batteries; which can be rechargeable, replaceable and/or disposable. The batteries ideally will be concealed within the book article itself as described above for aesthetic reasons. While the illustrative embodiments discussed above describe power supplied in a self contained fashion (e.g., by means of a battery, replaceable or rechargeable), external power (e.g., from a wall outlet or other external power source) can also be accommodated in lieu of or in parallel to (e.g., for rechargeability) the battery system as will be understood.

Any type of switch can be included to activate/deactivate the illumination system. For example, as is shown in the illustrative embodiments, a mechanical (i.e., on/off) switch is shown. Alternatively, light sensor activated, motion activated, voice activated, infrared, etc. can be incorporated in addition to or in lieu of the mechanical switch. Optionally a timer or a blinker may also be incorporated.

Sound generation features may also be incorporated for producing sound as a self-contained device. For example, in addition to use of external sound sources, microprocessors capable of playing sounds (e.g., narrative or music) and miniature sound producing elements can be integrated into the display book system.

The book article may be hung vertically, for example in a wall or as a Christmas ornament. To accommodate such use, a “lift-up tab” can be placed on the back of the article or at a different depth, e.g., at an internal page, for better balance, as will be appreciated. Such tab could be retractable (i.e., hide-away) in the event it is desired to use the article without its being hung (e.g., on a desk). For such vertical applications, a closure device, magnetic or otherwise, can be implemented that would keep the book closed while hanging, preventing unintended opening. A stand for desk display can also be used.

Alternatively, a light effect can be incorporated in the frame and not over or behind the image, but disposed about or around the image or object, e.g., along the viewing compartment or window perimeter. In such case, different construction of the box and different positions within the book according to the teachings herein will be understood. Such embodiment could be powered by replaceable batteries which are positioned somewhere within the device so as not to be externally viewable. For example, the batteries may be disposed in a battery compartment behind the viewing compartment in the center of the window-box where a neutral panel covers the battery compartment. Here, the image in such embodiment need not be translucent as it is not back lit and is preferably placed over the “neutral panel” area which conceals the battery compartment. The images in this embodiment can be interchangeable and additional images again may be housed in a “container” integrated to the book as discussed above.

An alternative illumination device can be devised to produce a diffuse light effect on the frame itself, which, in such embodiment, would preferably be built with translucent/transparent material.

However, the frame can also be built (e.g., with a mask) to include opaque and translucent regions, for example, to illuminate patterns. One embodiment could include a series of translucent openings with different shapes to allow the light to go through or alternatively, a colored screen can also be positioned behind the openings.

Alternatively, images to be displayed can also be formed in such mask configurations for use in a backlit application described above.

Furthermore, in yet another alternative, an “external” (i.e., external to the object displayed in the compartment, but still within the display system) light can be used to illuminate a displayed object or image in relief placed inside the box. In such embodiment, the illumination device would project light from over the top of the object to illuminate it. The possibility of devices to transmit the light all around the inside of the frame, to guarantee a better diffused light, is also envisioned. Using an object or image in relief better uses the depth available inside the box and provides a deeper viewing effect.

Modifications of the present invention utilizing the disclosed lighting system of the present invention in conjunction with a relief image can be done.

An alternative embodiment that utilizes the basic format (frame, passé-par-tout and image) can be designed with the teachings herein, using a stained glass window image printed on a piece of acetate with a light from the back and has a set of batteries positioned laterally near the spine.

FIGS. 9-27 will now be described in detail, each of which present illustrative embodiments consonant with the invention features, aspects and foregoing considerations for purposes of explanation.

FIG. 9 shows a perspective view of an illustrative embodiment according to the present invention for displaying a three dimensional object. A viewing compartment VC (also alternatively referred to as viewing “box”) for receiving the object to be displayed is formed by using a pass-par-tout 39 having a depth d and a frame 29. A book portion 49 is part of this display system embodiment.

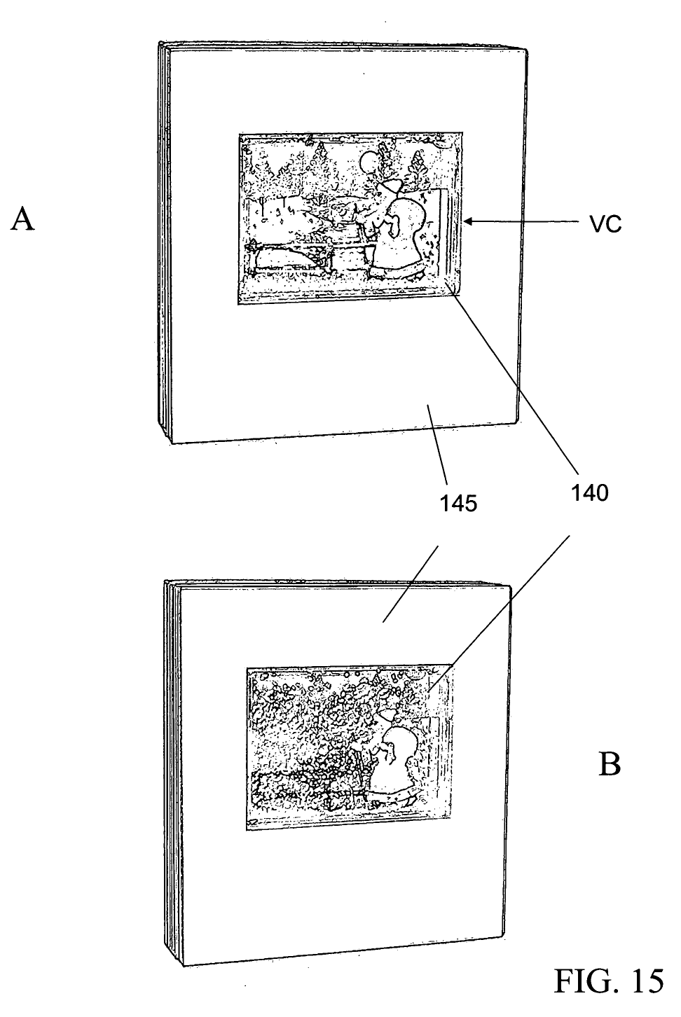

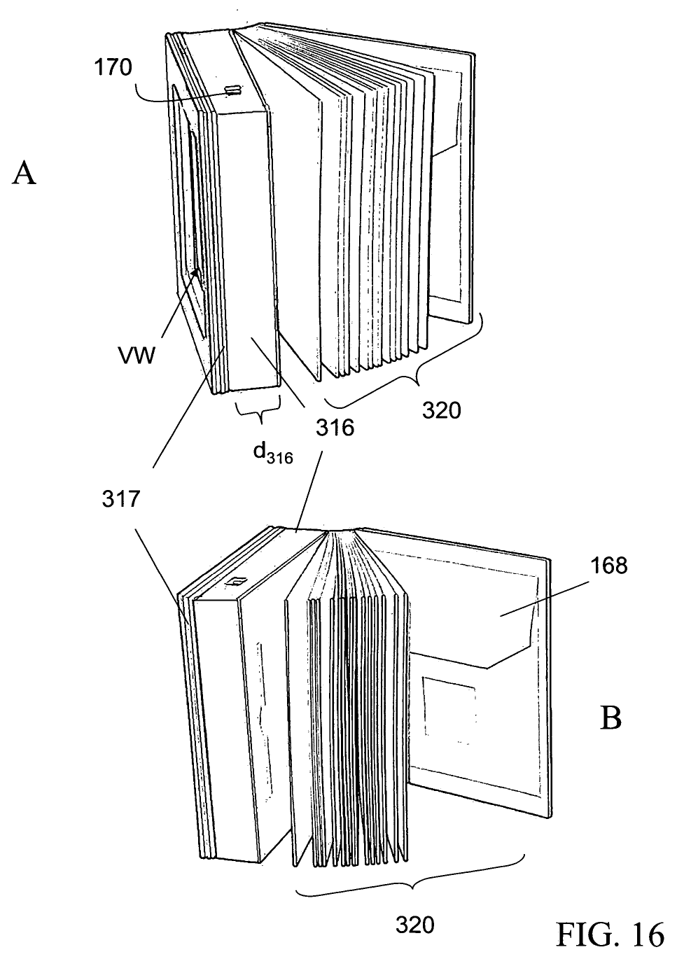

As shown in FIG. 10, a relief image 100 is hosted for display in viewing compartment VC. The depth d of the passé-par-tout 39 (and consequently of the viewing compartment) will be chosen in a dimension suitable to the size (i.e., depth, height and width) of the object to be displayed. It will be understood that any given depth d of compartment VC can receive and house an object for displaying with a depth of its own up to d. Of course, the depth of the object to be displayed can be greater than the depth of the viewing compartment; in which case, such object would extend beyond the face of the display frame but still held between the display frame and the compartment. (Although in alternative embodiments, see e.g., the discussion with respect to FIGS. 13B and C, the depth of the object displayed can exceed the depth of the passé-par-tout but still not extend beyond the display face.) Shown in FIGS. 11A and 11B is an illustrative embodiment according to the present invention for changeably displaying a three dimensional object. The object 110 to be displayed is made in a manner that will allow (changeable or permanent) placement within the viewing compartment VC. In the shown embodiment, object 110 is provided with a base 112. In this illustrated embodiment, the base 112 is magnetic for removable mounting; with an appropriate counterpart surface of the viewing compartment VC being of a magnetic material compatible to base 112. In this example, bottom surface VC_{bottom} is the counterpart surface to securely hold object 110. Alternatively, any or all surfaces of the viewing compartment may be compatible for magnetic mounting. In addition as a further enhancement, although not illustrated, it will be understood that a substantially two dimensional subject (e.g., a background photo) can be included in the viewing compartment VC, behind the three dimensional subject, to provide, for example, contextual background.

In the foregoing illustrations, for example, the respective frames of these embodiments may be made in the fashion described in the discussion, for example with respect to FIGS. 3-7, i.e. including a transparent or translucent pane.

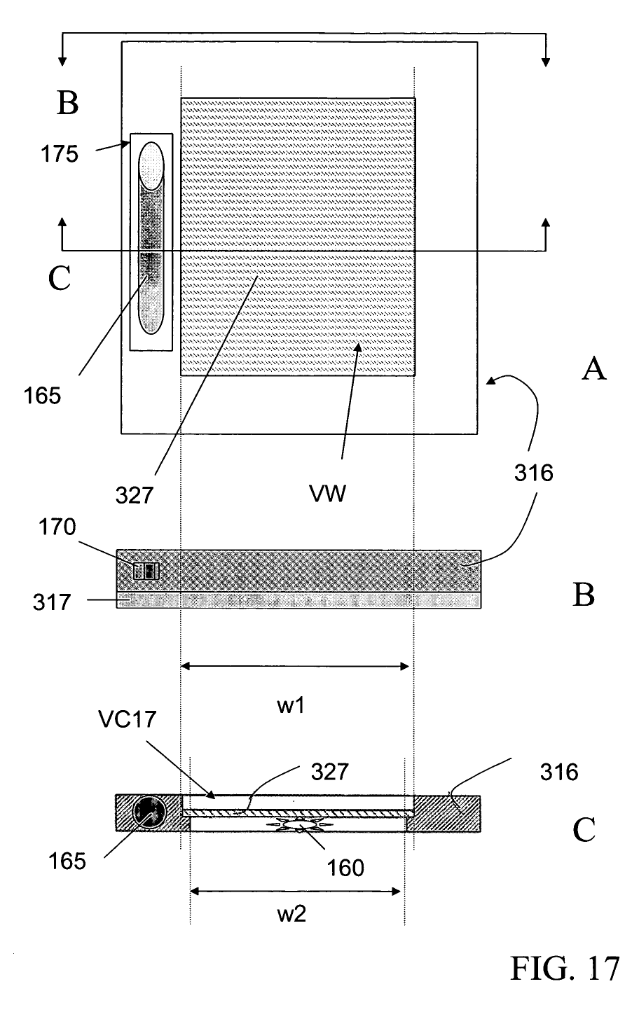

FIGS. 12A and 12B show an alternative illustrative embodiment according to the present invention for changeably displaying a three dimensional object or a diorama. The viewing compartment can be provided with a relevant background VC_{background} so that objects 120a and 120b each related to a similar theme can be interchanged. Again in this example, magnetic base mounting is provided, 122a and 122b, to bottom surface VC_{bottom}.

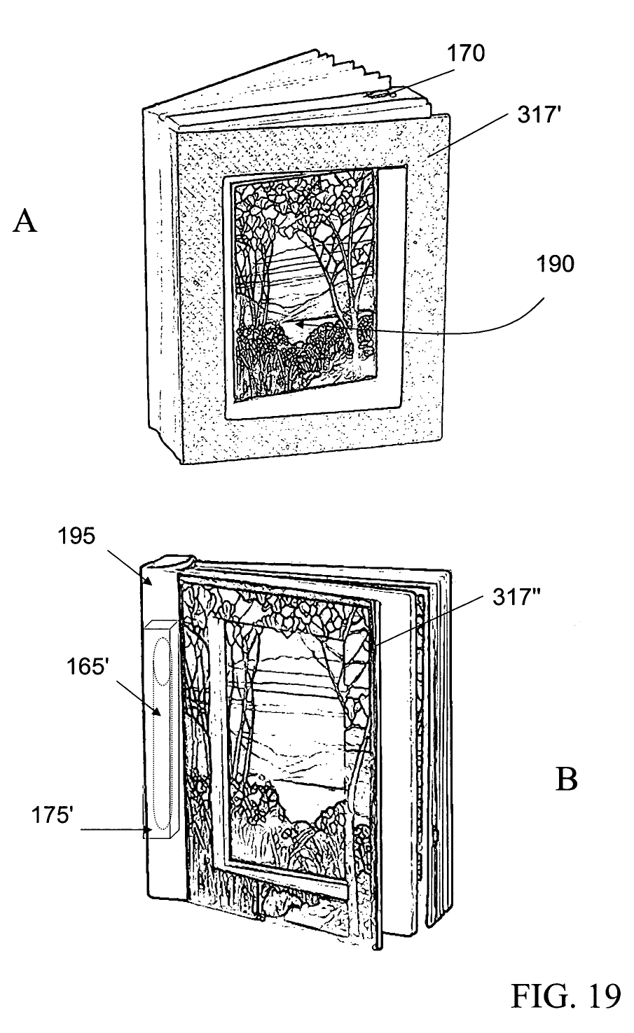

Alternatively, the entire three dimensional object 125 shown in FIG. 12 B could interchangeably fit into viewing compartment VC (FIG. 12A). See also FIGS. 14 and 15 and corresponding discussion infra.

FIGS. 13A and 13B show alternative illustrative embodiments according to the present invention for displaying three dimensional objects 130a and 130b. With respect to the embodiment shown in FIG. 13B, a feature of the invention is demonstrated where an object 130b which is deeper than the passé-par-tout forming the viewing compartment can be accommodated. As shown in FIG. 13C, object 130b extends beyond the face of the passé-par-tout by a distance p. The viewing frame 290 is of a depth Fd sufficient to accommodate protrusion distance p, thereby permitting flat closure of the book. A transparent pane can be accommodated as well in this embodiment, affixed at or toward the front face of the frame 290 (i.e., affixed to the frame so as to allow depth Fd for the object).

FIGS. 14 and 15A & 15B show an alternative illustrative embodiment according to the present invention for changeably displaying a three dimensional object. A self contained object can be displayed in the viewing compartment VC, where in this example, the illustrated object is a sealed unit 140 which depicts e.g., a seasonal theme. The illustrated object 140 is a variation of the well known fluid filled “snow” domes/globes, where, when the object is shaken, the effect of snowing is simulated. The size and dimension of the unit 140 will be complementary to the viewing compartment VC dimensions. (See FIG. 15.) Magnetic placement as described above or simple press-fit insertion can be used, as can any other suitable temporary or permanent mounting mechanism/method. Alternatively, the frame 145 can be made to open and can secure the object 140 by making the viewing window formed by an opening in the frame 145 slightly smaller than the viewing compartment/object 140 dimension, thereby securing the object when closed. Also, as discussed above, frame 145 may be made in the fashion described, for example, with respect to FIGS. 3-7, e.g., including a transparent or translucent pane.

Alternatively, instead of a fluid filled snow globe type object, the sealed compartment can be used to hold more than one fluid, each of different viscosity and/or color to yield viewable visual effects, e.g., where waves are simulated by two different viscosity fluids each of a different color.

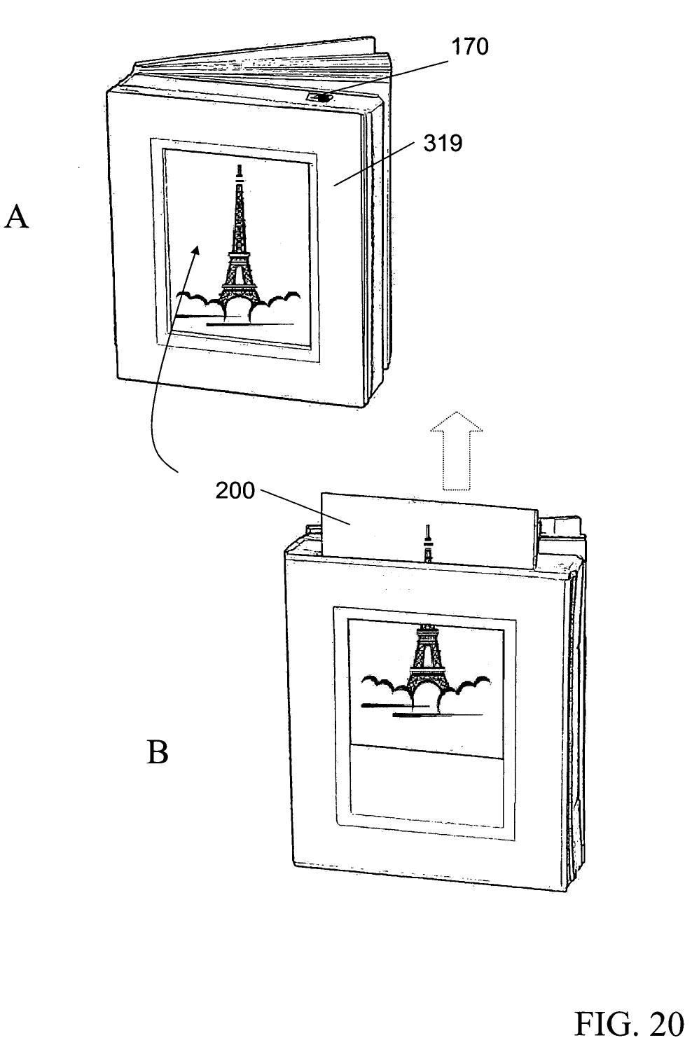

FIGS. 16, 17 and 18 show perspective views of an illustrative embodiment according to the present invention that includes an illumination system for displaying an object with illumination.

With reference to FIGS. 16A and B, passé-par-tout 316 is formed of depth d316 and is configured to provide an illumination source as will be explained. Frame 317 is positioned in a contiguous fashion to passé-par-tout 316, forming viewing window VW. A book portion 320 is provided. FIG. 16 also shows inclusion of a pouch 168 for storing, e.g., a CD or the like.

With reference now to FIGS. 17A, B and C, a frontal view is shown of the passé-par-tout 316 of FIG. 16. An illumination mechanism 160 is provided. Placement of a power source, in this embodiment, a battery compartment 175 and battery 165, is accommodated in the passé-par-tout 316. (See also FIG. 18 infra.) Switch 170 controls operation of the illumination system. While 2 batteries are typically used, in the illustrated preferred embodiments, only one battery is shown. One or more batteries can be arranged in the device (where they are hidden from view, or otherwise) to provide sufficient power for a given embodiment as will be understood.

Illumination mechanism 160 may be any light source suitable for the desired display effect, for example, LED or low voltage/wattage DC bulbs may be used. Although not essential, further display enhancement can be obtained through utilization of diffuser panel 327 (FIG. 17C) to provide a diffuse light source that will uniformly radiate light through viewing window VW. Use of this panel is effective to more uniformly backlight the object to be displayed which is placed in viewing compartment VC17 to be viewed through viewing window VW. To accommodate placement of the diffuser panel 327, in the illustration shown, the passé-par-tout 316 is formed in a step fashion with 2 different widths, w1 which substantially corresponds to the viewing window width, and w2, which is slightly smaller than w1 and forms a platform to hold 327 relative to light source 160. Other arrangements will be understood. Viewing compartment VC17 is formed relative to panel 327 as shown.

FIG. 18 illustrates a closeable cover 162 which is opened to reveal battery compartment 175 and battery 165, allowing, e.g., replacement of battery 165. A battery compartment cover 176 for a second battery compartment, as applicable, is also shown.

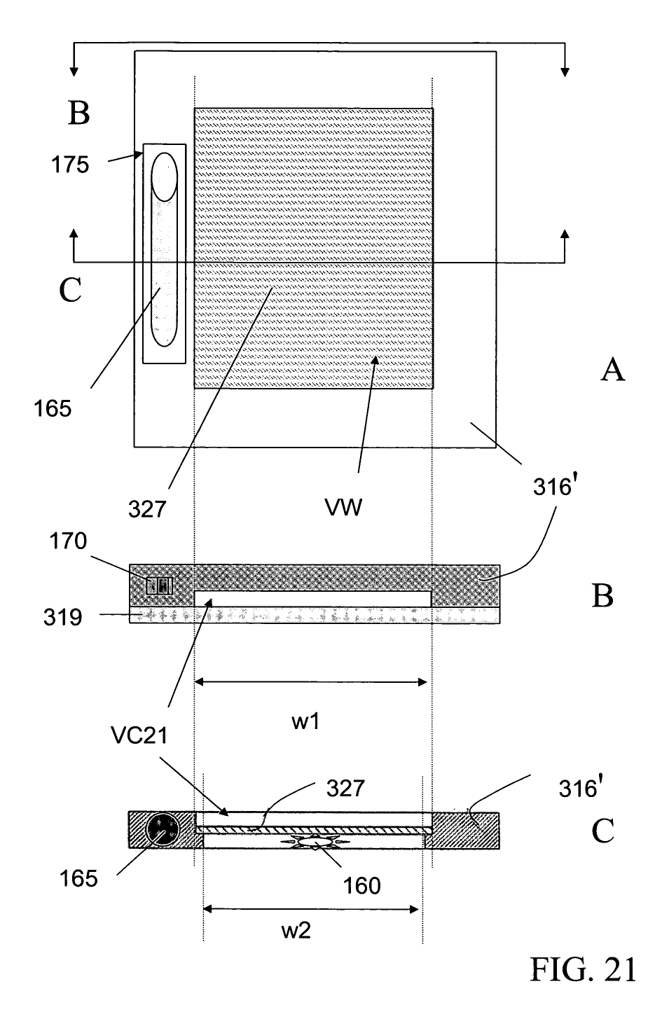

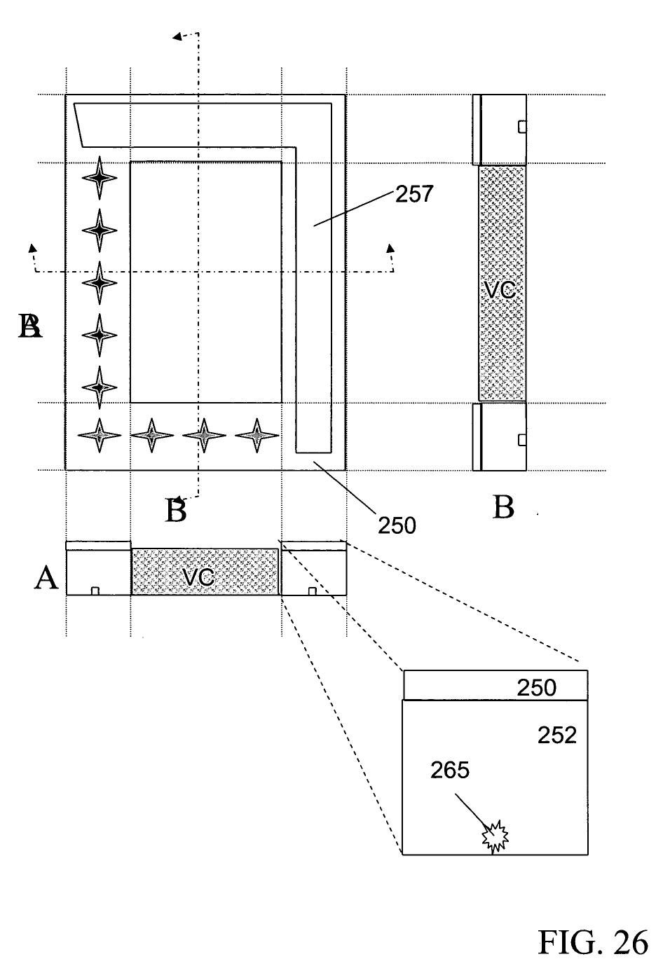

FIGS. 19A and 19B show illustrative implementations of the display system described in FIGS. 16-18. In FIG. 19A, the display is illustratively adapted to accommodate display of a picture object. More specifically, for example, the displayed object is formed as a translucent film (e.g., an acetate film) 190 bearing a picture image which is placed in the viewing compartment VC17 for viewing through window VW (See FIG. 17). The object 190 in this embodiment can be back-lit by the illumination mechanism (160 in FIG. 17, with or without diffuser panel 327, and operable by switch 170) and presents an illuminated image for viewing. FIG. 19B illustrates a backlit image display apparatus with alternative battery compartment 175′/battery 165′ placement in spine 195 of the book-like display system. In this embodiment, which utilizes the basic format (frame, passé-par-tout and image) a stained glass window image printed on a piece of acetate with a light from the back is provided in frame 317″ and has a set of batteries positioned laterally near the spine. The stained glass frame can itself be illuminated by implementation of the features discussed infra with relation to FIGS. 25 and 26.

FIGS. 20A and 20B and 21A, B & C show a variation to the display system described with respect to FIG. 19A. In this configuration, the object (e.g., a backlit image) to be displayed 200 is interchangeable without the need to open frame 319 to access the viewing compartment. In this embodiment, an opening is provided through which object 200 is removably inserted into the viewing compartment. As shown in FIG. 21, passé-par-tout 316′ is formed such that the viewing compartment VC21 extends through to the top of the passé-par-tout (as seen from viewpoint B in FIG. 21A). It is through this open viewing compartment VC21 that object 200 is insertable and removable.

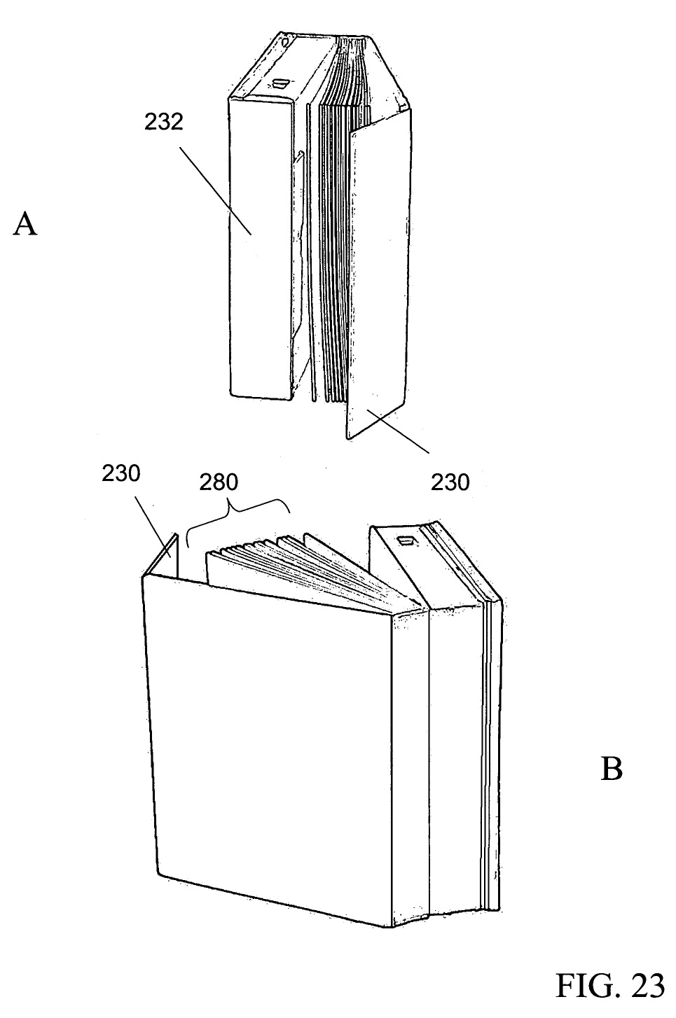

FIGS. 22A and B show illustrative embodiments of modifications of the embodiments described with respect to FIGS. 13A and B. wherein the displayed object is illuminated. With reference to FIG. 22A, the object of FIG. 13A, 130a, is itself illuminated with an illumination mechanism 220a. With reference to FIG. 22B, the object of FIG. 13B, 130b, is top illuminated with an illumination mechanism 220b. In either instance, a switch is preferably provided by which the illumination mechanism can be turned on or off (not shown).

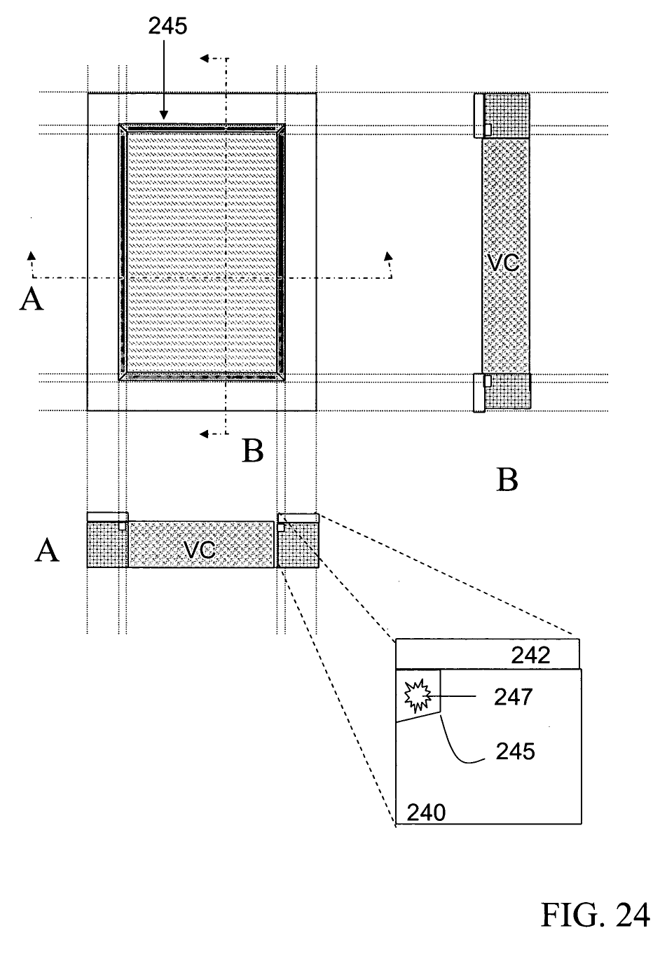

FIG. 23 shows an embodiment of the display device where the device is itself closeable by means of a flap 230. The flap has compatible counterpart surface 232 to keep the flap, and consequently the display device, securely closed. For example, the closure mechanism for the flap may be: magnetic, where the flap 230 and counterpart surface 232 are magnetic materials of opposite polarity; hook and loop (e.g., Velcro®), or any other suitable mechanical or other method, with flap 230 and counterpart surface 232 appropriately configured. Other mechanisms to secure the book portion 280 in a closed manner can be devised.

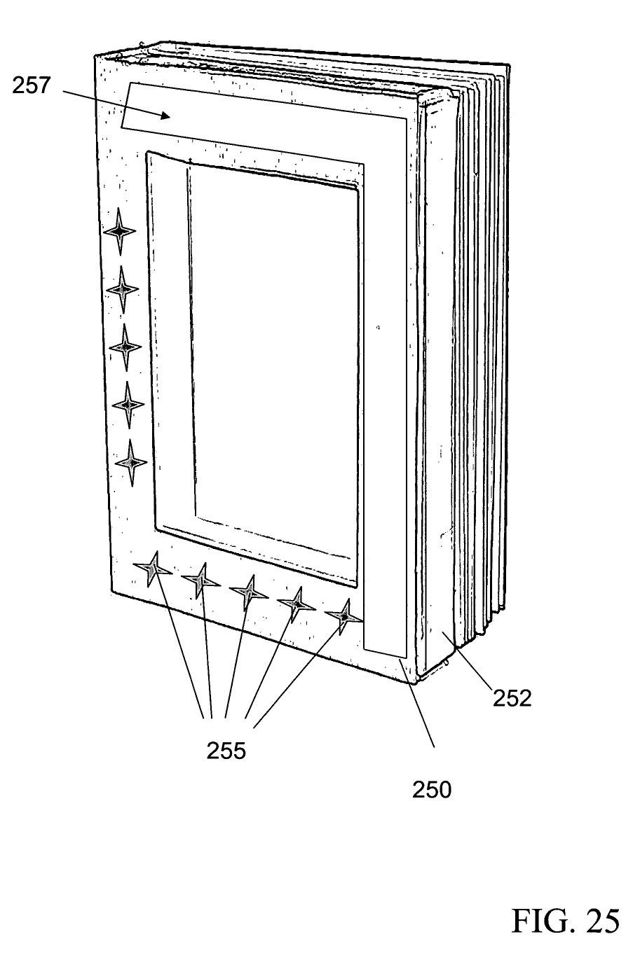

FIG. 24 shows an illustrative embodiment according to the present invention providing for front- or perimeter illumination of an object (not shown) hosted in viewing compartment VC. An illumination channel 245 is provided in the passé-par-tout 240. The channel is preferably positioned toward the front of the passé-par-tout (i.e., closer to the frame 242) and is configured so as to allow illumination of the viewing compartment VC as desired. An illumination source 247 is provided in channel 245. Any suitable light source 247 can be implemented. The channel 245 be formed around the entire perimeter of the viewing compartment (as shown in the illustration) or the channel can be formed in any number discrete segments each shorter than the entire lengths or widths forming the perimeter of the viewing compartment. For example, a channel segment can be provided in the span of each or any length or width portions of the viewing compartment.

Alternatively, the passé-par-tout 240 can be formed as a hollow box with an illumination source 247 disposed therein. (See FIG. 26 discussed infra.) Any suitable light source can be used.

FIGS. 25 and 26 show an illustrative embodiment for including an illuminated pattern or design mosaic on the frame. The passé-par-tout 252 is formed as a hollow box with an illumination source 265 disposed therein. Any suitable light source can be used. Frame 250 can be provided with cutout portions 255 of any desired shape or pattern through which light from source 265 will radiate. Alternatively or in combination with cutouts 255 as shown in FIGS. 25 and 26, a cutout perimeter 257 can be provisioned such that a translucent film can be affixed thereto and illuminated from source 265.

In the foregoing embodiments discussing the use of perimeter lighting (e.g., 247 in FIG. 24 or 265 in FIG. 26), lateral effect optical fibers can be used, which typically comprise one or 2 point sources at one or each end, and which radiate light perpendicular to the axis of the fiber. This can be used around the entire perimeter of the viewing window, or a portion thereof, or as the light source for the pattern/design mosaic embodiment in the passé-par-tout.

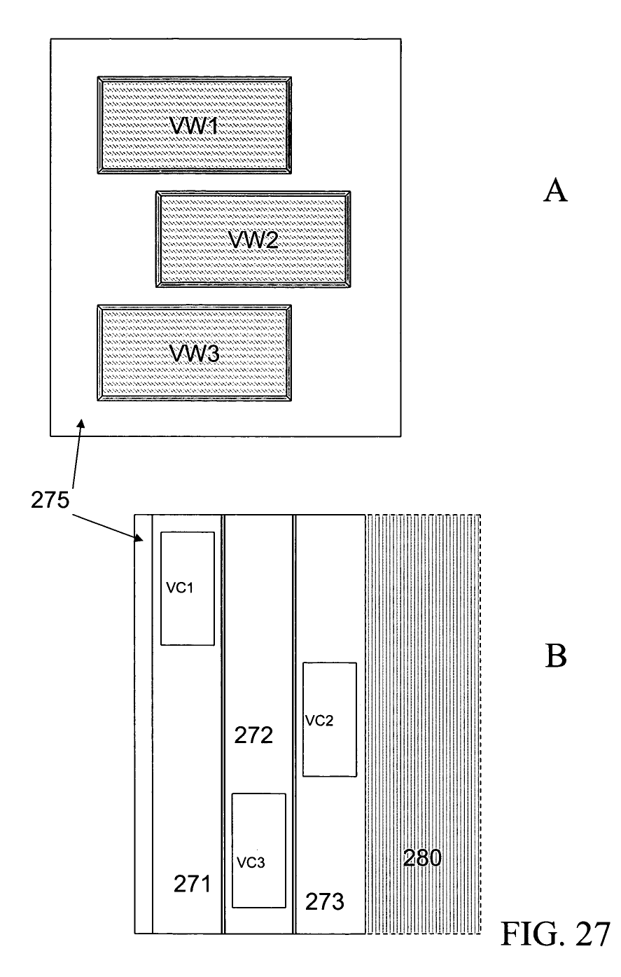

FIG. 27 shows an illustrative embodiment according to the present invention for displaying multiple objects. The display system is provided with multiple, in this example 3, viewing windows VW1, VW2 and VW3 (each comprising respective viewing compartments in accordance with the teachings of the present invention as heretofore described). As shown in FIG. 27B, in alternative embodiments the compartments can be positioned in different planes at different depths in the display book, each compartment VC1, VC2 and VC3 being independently viewable behind frame 275. In this illustration, each compartment is shown in a different passé-par-tout portion 271, 272 and 273. Book portion 280 may also be provided. Alternative designs may be devised using the teachings of the present invention where a combination of two and three dimensional subjects are displayed in the same display system.

Systems made according to the inventive features incorporated into the various embodiments of the present invention allow displaying of myriad objects, both two and/or three dimensional, illuminated or not. Advantages of the present invention include flexibility interoperability of compatible display system features heretofore described which can be used in any combination as will be understood to achieve visibility/viewability of, and ease of access to (for interchangeability), display images or objects. Many other implementations can be devised using the foregoing described features, aspects and design considerations.

The present invention has been illustrated and described with respect to specific embodiments thereof, which embodiments are merely illustrative of the principles of the invention and are not intended to be exclusive or otherwise limiting embodiments. For instance, although the description provided hereinabove along with the accompanying drawings illustrate particular embodiments incorporating one or a few features of the present invention, those skilled in the art will understand in view of the hereinabove disclosure that alternative configurations can be devised and implemented, as well as other designs capable of achieving the purpose and benefits of the discussed aspects of the invention.

Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. It is therefore intended that the present invention is not limited to the disclosed embodiments but should be defined in accordance with the claims that follow.

We claim:

1. An article in the form of a book comprising a plurality of pages ordered and bound together, the article comprising:
a first page of the plurality of pages of the book, the first page consisting essentially of a frame which defines a viewing window; and
a viewing compartment comprising a second page of the plurality of pages which follows the first page and which is capable of presenting a subject in a position aligned with the viewing window of the frame such that the subject is visible through the window of the frame.

2. The article according to claim 1, wherein the viewing compartment is substantially constituted by a passé-par-tout which defines the viewing compartment.

3. The article according to claim 1, further comprising an illumination system.

4. The article according to claim 3, wherein said illumination system is disposed within said viewing compartment.

5. The article according to claim 3, wherein said illumination system is disposed behind said viewing compartment.

6. The article according to claim 3, wherein said illumination system is disposed substantially about the perimeter, or any portion thereof, of the viewing window.

7. The article according to claim 2, further comprising an illumination system disposed in the passé-par-tout.

8. The article according to claim 3, wherein the illumination system is provided in the subject disposed in the viewing compartment.

9. The article according to claim 1, wherein the subject is substantially a two dimensional object.

10. The article according to claim 1, comprising a plurality of viewing compartments disposed through the plurality of pages of said book.

11. The article according to claim 2, comprising a plurality of viewing compartments, each disposed in its own passé-par-tout.

12. The article according to claim 11, wherein at least one viewing compartment has its own illumination system.

13. The article according to claim 1 further comprising a closure device adapted to keep all the pages closed together.

14. The article according to claim 1, wherein the subject is substantially a three dimensional object.

15. The article according to claim 10, wherein at least one viewing compartment of said plurality is capable of presenting a substantially two dimensional subject and at least one viewing compartment of said plurality is capable of presenting a three dimensional subject

16. The article according to claim 1, further comprising a device adapted to hang the article on a wall.

17. The article according to claim 7, wherein the first page frame comprises a mask and is illuminated through the passé-par-tout.

18. The article according to claim 5, wherein the subject is a translucent image.

19. The article according to claim 9, wherein the two dimensional object is removably disposed in the viewing compartment.

20. The article according to claim 14, wherein the three dimensional object is removably disposed in the viewing compartment.
